(19) United States
(12) Patent Application Publication
(10) Pub. No.: US 2019/0393740 A1
(43) Pub. Date: Dec. 26, 2019

(54) STATOR AND ROTARY ELECTRIC MACHINE

(71) Applicant: HONDA MOTOR CO., LTD., Tokyo (JP)

(72) Inventor: Masashi Yokoi, Tokyo (JP)

(21) Appl. No.: 16/441,101

(22) Filed: Jun. 14, 2019

(30) Foreign Application Priority Data
Jun. 22, 2018 (JP) 2018-119064

(51) Int. Cl. H02K 1/16; H02K 15/02; H02K 3/48; H02K 1/14

(52) U.S. Cl. CPC H02K 1/165; H02K 1/146; H02K 3/48; H02K 15/024

(57) ABSTRACT

A stator includes a coil that has a surface surrounded by an insulating coating and an insulating paper, and a stator core (11) that is formed of stacked plates (14) and has a slot (23) in which the coil is mounted. The stator core (11) includes an end surface side portion (61) which forms a part of the stator core (11) on an end surface side to be in contact with a case, and a general portion (71) which forms a part other than the end surface side portion (61). The general portion (71) includes a plurality of general teeth (73) which are provided at intervals in a circumferential direction of the stator core (11) and of which distal ends have a flange portion extending in the circumferential direction. End surface side teeth (63) serving as non-contact portions, which are incapable of coming into contact with the coil in a radial direction even if the end surface side portion (61) is displaced outward in the radial direction of the stator core (11), are provided in the end surface side portion (61).

### CROSS REFERENCE TO RELATED APPLICATIONS

Priority is claimed on Japanese Patent Application No. 2018-119064, filed on Jun. 22, 2018, the contents of which are entirely incorporated herein by reference.

### BACKGROUND OF THE INVENTION

### Field of the Invention

The present invention relates to a stator and a rotary electric machine.

### Description of Related Art

In the related art, rotary electric machines are used as power sources for hybrid automobiles and electric automobiles. A rotary electric machine includes a stator. For example, a stator in Japanese Unexamined Patent Application, First Publication No. 2010-279232 includes a stator core and coils. The stator core is formed to have an annular shape in which a plurality of annular plates are stacked in an axial direction. The coil is surrounded by an insulating portion including a film, an insulating paper, and the like. An attachment portion of the stator core is fixed to a case (stator support member) by a bolt, for example. A plurality of teeth are provided on an inner circumferential surface of a back yoke portion at intervals in a circumferential direction. Slots are formed between teeth adjacent to each other in the circumferential direction such that the coils are accommodated therein. A tooth has a tooth main body and a flange portion.

### SUMMARY OF THE INVENTION

Incidentally, a difference between the coefficient of linear expansion of an electromagnetic steel sheet used for stator cores and the coefficient of linear expansion of aluminum used for stator support members results in the following problem, for example. That is, when the temperatures of a stator core and a stator support member rise, an end surface side portion of the stator core is pulled outward in a radial direction by the stator support member and is displaced outward in the radial direction due to a difference between the coefficients of linear expansion of the stator core and the stator support member. At this time, there is concern that flange portions of teeth may come into contact in the radial direction with an insulating portion including an insulating film, an insulating paper, and the like surrounding a coil.

An object of an aspect of the present invention is to provide a stator, in which a coil can be prevented from coming into contact with an insulating portion in a radial direction while influence on performance is limited, and a rotary electric machine including this stator.

According to an aspect of the present invention, there is provided a stator (for example, a stator 3 in the embodiment described below) including a coil (for example, a coil 12 in the embodiment described below) that has a surface surrounded by an insulating portion (for example, an insulating coating 8a and an insulating paper 8b in the embodiment described below), and an annular stator core (for example, a stator core 11 in the embodiment described below) that is formed of stacked plates (for example, plates 14 in the embodiment described below) and has a slot (for example, a slot 23 in the embodiment described below) in which the coil is mounted. The stator core includes an end surface side portion (for example, an end surface side portion 61 in the embodiment described below) which forms a part of the stator core on an end surface side to be in contact with a stator support member (for example, a case 2 in the embodiment described below), and a general portion (for example, a general portion 71 in the embodiment described below) which forms a part other than the end surface side portion. The general portion includes a plurality of general teeth (for example, a plurality of general teeth 73 in the embodiment described below) which are provided at intervals in a circumferential direction of the stator core and of which distal ends have a flange portion (for example, a flange portion 76 in the embodiment described below) extending in the circumferential direction. Non-contact portions (for example, end surface side teeth 63 in the embodiment described below), which are incapable of coming into contact with the coil in a radial direction even if the end surface side portion is displaced outward in the radial direction of the stator core, are provided in the end surface side portion.

In the aspect, for example, the end surface side portion may have an end surface side back yoke portion (for example, an end surface side back yoke portion 62 in the embodiment described below) stacked in the general portion on an outer side of the general teeth in the radial direction. The non-contact portions may be provided on an inner circumference side of the end surface side back yoke portion.

In the aspect, for example, the end surface side portion may have end surface side teeth (for example, a plurality of end surface side teeth 63 in the embodiment described below) stacked in the general teeth. The non-contact portions may be constituted of the end surface side teeth which are formed to have a linear shape in the radial direction.

In the aspect, for example, both corner portions (for example, both corner portions 108 and 108 in the embodiment described below) in distal end portions of the end surface side teeth may have a chamfered shape.

In the aspect, for example, the end surface side teeth may protrude inward in the radial direction beyond the general teeth.

In the aspect, for example, the attachment portions (for example, attachment portions 24 in the embodiment described below) for being attached to the stator support member may be provided in the stator core. The non-contact portions may be provided at only positions corresponding to the attachment portions.

According to another aspect of the present invention, there is provided a rotary electric machine (a rotary electric machine 1 in the embodiment described below) including the stator described above.

According to the stator in the aspect of the present invention, since the non-contact portions are provided on the inner circumference side of the end surface side portion of the stator core, even when the end surface side portion of the stator core is pulled and displaced outward in the radial direction due to a difference between the coefficients of linear expansion of the stator core and the stator support member, contact of the coil with the insulating portion in the radial direction can be limited. In addition, since each of the general teeth has a flange portion similar to stator cores in the related art, even if the non-contact portions are provided, influence on performance of the stator can be limited. Therefore, it is possible to provide a stator in which the coil can be prevented from coming into contact with the insulating portion in the radial direction while influence on performance is limited.

In the aspect, since the non-contact portions are provided on the inner circumference side of the end surface side back yoke portion, manufacturing can be easily performed simply by adding one die to a progressive die for manufacturing a general portion. Thus, according to the stator, the coil can be prevented from coming into contact with the insulating portion in the radial direction while the manufacturing cost is reduced.

In the aspect, since the non-contact portions are constituted of the end surface side teeth which are formed to have a linear shape in the radial direction, the coil can be prevented from coming into contact with the insulating portion in the radial direction while influence on performance of the stator is further limited.

In the aspect, since both the corner portions in the distal end portions of the end surface side teeth have a chamfered shape, even if the end surface side portion of the stator core is displaced in the radial direction and the circumferential direction, the coil can be prevented from coming into contact with the insulating portion in the radial direction.

In the aspect, since the end surface side teeth protrude inward in the radial direction beyond the general teeth, even if the end surface side portion of the stator core is displaced outward in the radial direction due to a difference between the coefficients of linear expansion, positions of the distal end portions of the end surface side teeth and positions of distal end portions of the general teeth can be substantially the same as each other. Therefore, the coil can be prevented from coming into contact with the insulating portion in the radial direction while influence on performance of the stator is further limited.

In the aspect, since the non-contact portions are provided at only positions corresponding to the attachment portions, an installation range for the non-contact portions can be minimized Therefore, the coil can be prevented from coming into contact with the insulating portion in the radial direction while influence on performance of the stator is further limited.

According to the rotary electric machine in the aspect of the present invention, it is possible to achieve a high-performance rotary electric machine in which the coil can be prevented from coming into contact with the insulating portion in the radial direction while influence on performance is limited.

### BRIEF DESCRIPTION OF THE DRAWINGS

FIG. 1 is a cross-sectional view showing a schematic configuration of a rotary electric machine including a stator of a first embodiment.

FIG. 2 is a plan view of a stator core.

FIG. 3 is a perspective view of the stator core.

FIG. 4 is a plan view of a general portion of the stator core.

FIG. 5 is a plan view of an end surface side portion of the stator core.

FIG. 6 is a cross-sectional view of a part of the stator.

FIG. 7 is a perspective view showing a segment coil.

FIG. 8 is a perspective view showing displacement of the stator core.

FIG. 9 is a perspective view of a stator core of a stator in a second embodiment.

FIG. 10 is a plan view of an end surface side portion of the stator core.

FIG. 11 is a perspective view showing displacement of the stator core.

FIG. 12 is a perspective view of a stator core of a stator in a third embodiment.

FIG. 13 is an enlarged view of a part E in FIG. 12.

FIG. 14 is a perspective view showing displacement of the stator core.

### DETAILED DESCRIPTION OF THE INVENTION

Hereinafter, embodiments of the present invention will be described with reference to the drawings.

### First embodiment

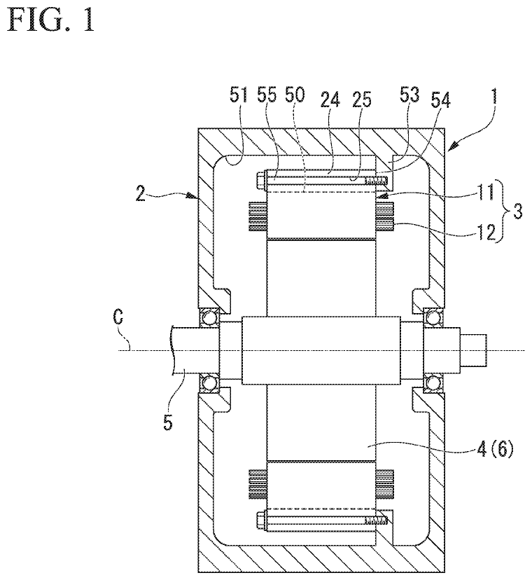

A stator 3 of a first embodiment will be described. FIG. 1 is a cross-sectional view showing a schematic configuration of a rotary electric machine including the stator of the first embodiment. For example, a rotary electric machine 1 of the present embodiment is a motor for traveling mounted in vehicles such as hybrid automobiles and electric automobiles. However, the configuration of the present embodiment is not limited to the foregoing example and can also be applied to motors for other purposes such as motors for power generation mounted in vehicles. In addition, the configuration of the present embodiment can be applied to rotary electric machines other than those mounted in vehicles, that is, all so-called rotary electric machines including a generator.

As shown in FIG. 1, the rotary electric machine 1 according to the first embodiment includes a case 2, the stator 3, a rotor 4, and an output shaft 5. The output shaft 5 is rotatably supported by the case 2. The rotor 4 has a rotor core 6 and a magnet (not shown) attached to the rotor core 6. The rotor core 6 is formed to have a cylindrical shape externally fitted to the output shaft 5. In the following description, there are cases in which a direction along an axis C of the output shaft 5 is referred to as an axial direction, a direction orthogonal to the axis C is referred to as a radial direction, and a direction around the axis C is referred to as a circumferential direction.

The case 2 (corresponding to “the stator support member” in the claims) is formed to have a cylindrical shape. The stator 3 and the rotor 4 are accommodated inside the case 2. The case 2 of the present embodiment is formed of aluminum. A case side attachment portion 53 is provided on an inner circumferential surface 51 of the case 2. The case side attachment portion 53 is formed in a manner protruding inward in the radial direction from the inner circumferential surface 51. A stator core 11 (which will be described below) is fastened and fixed to the case side attachment portion 53 using bolts 55.

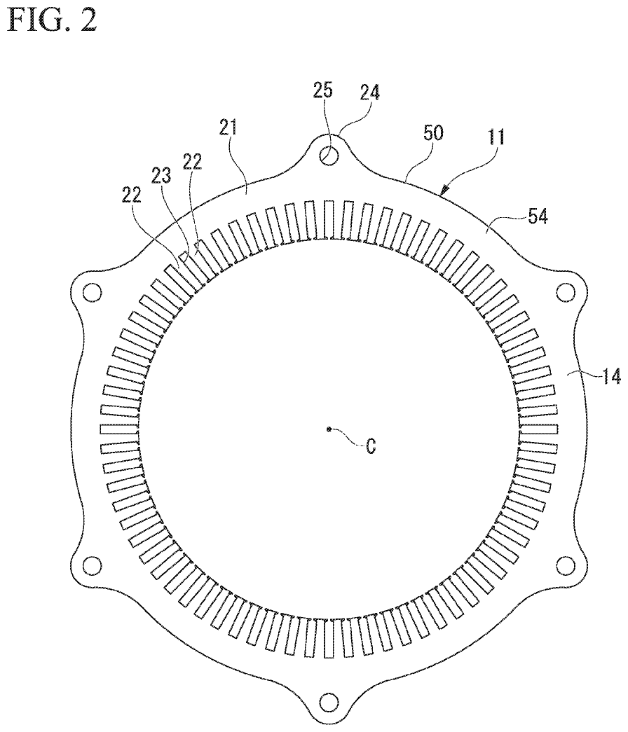

FIG. 2 is a plan view of the stator core. As shown in FIGS. 1 and 2, the stator 3 includes the stator core 11 and a coil 12 which is mounted in the stator core 11. The stator core 11 is formed to have an annular shape (cylindrical shape) surrounding the rotor 4 from the outside in the radial direction. The stator core 11 is constituted of a plurality of annular plates 14 which are formed of an electromagnetic steel sheet subjected to punching or the like and are stacked in the axial direction.

The stator core 11 has a back yoke portion 21 and a plurality of teeth 22. The back yoke portion 21 is disposed coaxially with the axis C and is formed to have an annular shape when viewed in the axial direction. Attachment portions 24 protruding outward in the radial direction are formed on an outer circumferential surface 50 of the back yoke portion 21. The attachment portions 24 are formed at six places at equal intervals in the circumferential direction. The number, the positions, and the like of the attachment portions 24 can be suitably changed. An attachment hole 25 penetrating in the axial direction is formed in the attachment portion 24. The bolt 55 is inserted through the attachment hole 25. The stator core 11 is fastened and fixed to the case side attachment portion 53 of the case 2 by the bolts 55 inserted through the attachment holes 25.

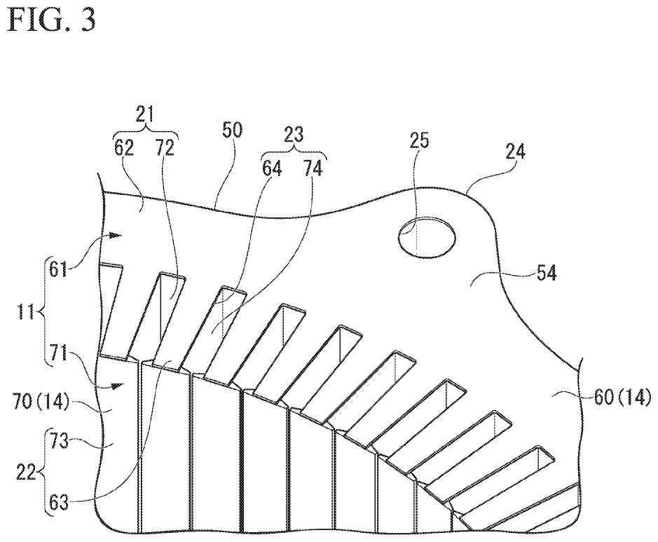

FIG. 3 is a perspective view of the stator core 11. As shown in FIG. 3, the stator core 11 includes an end surface side portion 61 and a general portion 71. The end surface side portion 61 is a part of the stator core 11 on an end surface 54 side and is a part which comes into contact with the case side attachment portion 53 (refer to FIG. 1) when the stator core is fastened and fixed to the case 2. The general portion 71 is a part other than the end surface side portion 61 of the stator core 11.

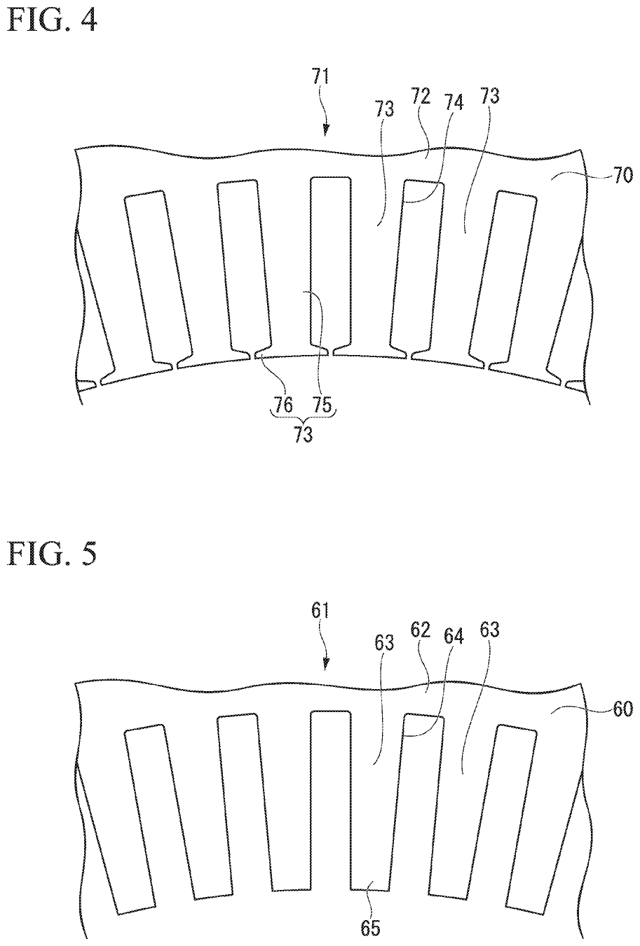

FIG. 4 is a plan view of the general portion. As shown in FIGS. 3 and 4, the general portion 71 is formed of a predetermined number of general plates 70 which are stacked in the axial direction. The general portion 71 has a general back yoke portion 72 and a plurality of general teeth 73. The general back yoke portion 72 is disposed coaxially with the axis C and is formed to have an annular shape when viewed in the axial direction.

The plurality of general teeth 73 are provided on an inner circumferential surface of the general back yoke portion 72 at intervals in the circumferential direction. The general tooth 73 has a general tooth main body 75 and a flange portion 76. The general tooth main body 75 protrudes inward in the radial direction from the inner circumferential surface of the general back yoke portion 72. The general tooth main body 75 is linearly formed in the radial direction. The flange portion 76 is provided at a distal end of the general tooth main body 75. The flange portion 76 projects from the general tooth main body 75 in the circumferential direction. A general slot 74 is formed between the general teeth 73 and 73. The coil 12 (which will be described below) is accommodated in the general slot 74.

FIG. 5 is a plan view of the end surface side portion. As shown in FIGS. 3 and 5, the end surface side portion 61 is formed of one end surface side plate 60. The end surface side portion 61 is not limited to the form of being formed of one end surface side plate 60. For example, a form in which the end surface side portion 61 is formed by stacking a plurality of end surface side plates 60 (for example, approximately two to five plates) in the axial direction may be adopted.

The end surface side portion 61 has an end surface side back yoke portion 62 and a plurality of end surface side teeth 63. Similar to the general back yoke portion 72, the end surface side back yoke portion 62 is disposed coaxially with the axis C and is formed to have an annular shape.

The plurality of end surface side teeth 63 are provided on the inner circumferential surface of the end surface side back yoke portion 62 at intervals in the circumferential direction. The intervals of the plurality of end surface side teeth 63 correspond to the intervals of the plurality of general teeth 73. The end surface side teeth 63 are formed in a manner protruding inward in the radial direction from the inner circumferential surface of the end surface side back yoke portion 62. The end surface side teeth 63 are linearly formed in the radial direction. The lengths of the end surface side teeth 63 in the radial direction are set to the same length as the lengths of the general teeth 73 in the radial direction. As in the general tooth 73, no flange portion 76 is formed in a distal end portion 65 of the end surface side tooth 63. The end surface side teeth 63 are non-contact portions which are incapable of coming into contact with the coil 12 in the radial direction even if the end surface side portion 61 is displaced outward in the radial direction. An end surface side slot 64 is formed between the end surface side teeth 63 and 63. The end surface side slot 64 is formed in a manner corresponding to the general slot 74. The coil 12 (which will be described below) is accommodated in the end surface side slot 64.

As shown in FIG. 3, a plurality of plates 14 of the stator core 11 are constituted of one end surface side plate 60 described above and a predetermined number of general plates 70. The back yoke portion 21 of the stator core 11 is formed of the end surface side back yoke portion 62 and the general back yoke portion 72 described above. In addition, the plurality of teeth 22 of the stator core 11 are formed of the end surface side teeth 63 and the general teeth 73 described above. A slot 23 of the stator core 11 is formed of the end surface side slot 64 and the general slot 74 described above.

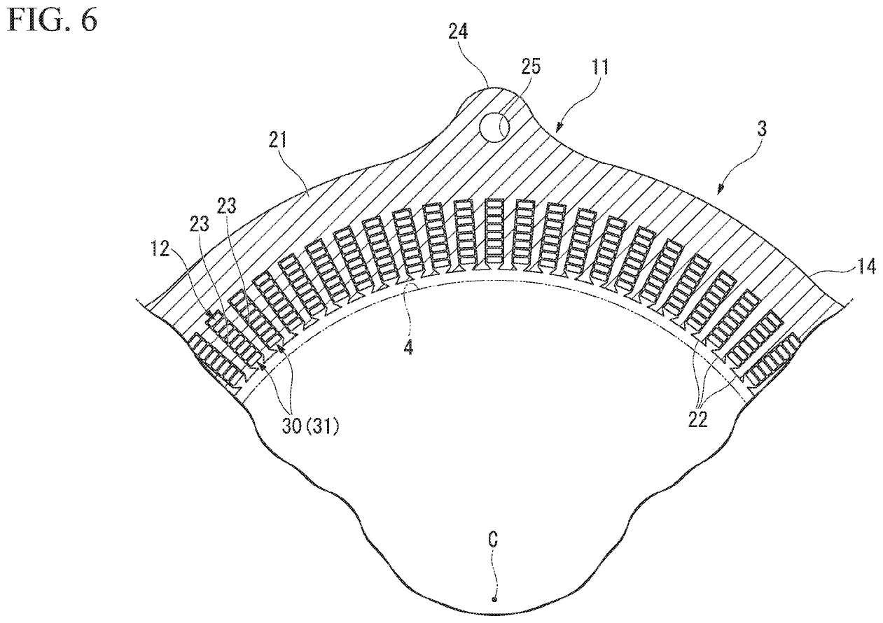

FIG. 6 is a cross-sectional view of a part of the stator. As shown in FIG. 6, the coil 12 is mounted in the stator core 11 in a state in which a portion thereof is accommodated inside the slot 23 of the stator core 11. The coil 12 has three phases including a U-phase, a V-phase, and a W-phase. Each coil 12 of each phase is configured to have a plurality of segment coils 30 joined to each other.

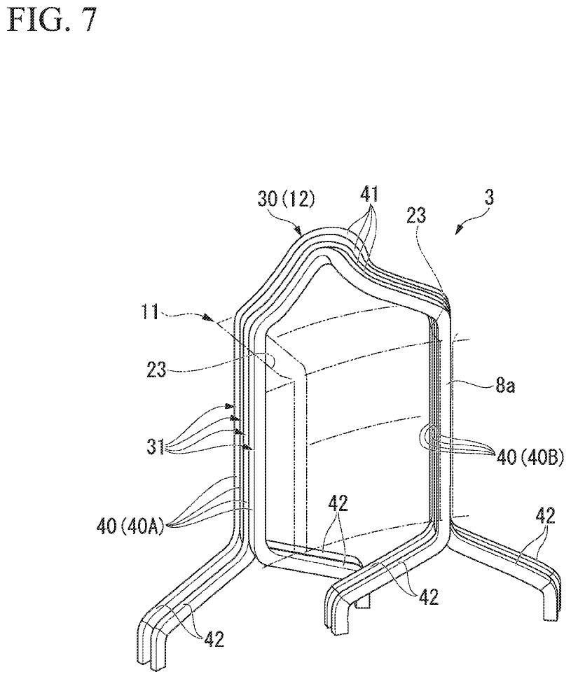

FIG. 7 is a perspective view showing one segment coil. As shown in FIG. 7, the segment coil 30 is configured to have a plurality (four, for example) of segment conductors 31 overlapping in the radial direction. In each of the segment conductors 31, a core wire is covered with an insulating coating 8a (corresponding to “the insulating portion” in the claims). Each of the segment conductors 31 is a rectangular wire, for example. A cross-sectional shape of each segment conductor 31 orthogonal to the extending direction is formed to have a rectangular shape.

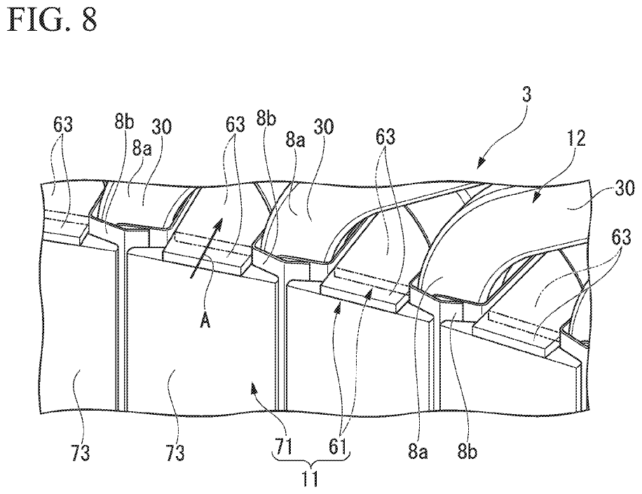

Each of the segment conductors 31 has two linear portions 40 (40A and 40B), a first connection portion 41, and two second connection portions 42. The linear portions 40A and 40B extend in the axial direction in a manner of being parallel to each other. The linear portions 40A and 40B are accommodated in separate slots 23 different from each other in a state of being surrounded by an insulating paper 8b (refer to FIG. 8, corresponding to “the insulating portion” in the claims).

The first connection portion 41 connects end portions of the two linear portions 40A and 40B in the axial direction each other outside the slot 23. The second connection portions 42 respectively lead to the end portions of the linear portions 40A and 40B in the axial direction and are drawn out of the slot 23. The core wire is exposed in the end portions of the second connection portions 42. One second connection portion 42 of the pair of second connection portions 42 is connected to a second connection portion 42 of another segment coil 30 through TIG welding or laser welding, for example. The other second connection portion 42 is bonded to a second connection portion 42 of another segment coil 30. Accordingly, the plurality of segment coils 30 are sequentially joined to each other.

A plurality of segment conductors 31 inserted into the same slot 23 are arranged in a row in the radial direction of the stator core 11. That is, the linear portions 40A and 40B of the segment conductors 31 are arranged inside the same slot 23 such that the short side direction coincides with the radial direction and the long side direction intersects the radial direction. A current of the same phase of three phases including the U-phase, the V-phase, and the W-phase flows in the plurality of segment conductors 31 constituting one segment coil 30.

The segment coils 30 are inserted into the slots 23 from the outside of the stator core 11 in the axial direction of the stator core 11. Specifically, the segment coils 30 are inserted into the slots 23 in a state in which the second connection portions 42 extend in a straight line with respect to the linear portions 40A and 40B. In the segment coils 30, after the linear portions 40A and 40B are inserted into the slots 23, each of the second connection portions 42 is bent in the circumferential direction such that the bending directions become directions opposite to each other between the segment conductors 31 adjacent to each other the radial direction. Accordingly, the segment coils 30 adjacent to each other in the circumferential direction are connected to each other via the second connection portions 42.

Next, a method for manufacturing the stator core 11 will be described. For example, the stator core 11 is manufactured using a progressive die. First, a strip-like electromagnetic steel sheet conveyed in a product line is punched a plurality of times using a die for forming a rotor. Accordingly, a plate for a rotor core is formed. Subsequently, the remaining electromagnetic steel sheet is punched a plurality of times using a die for forming a general plate 70. Accordingly, a predetermined number of general plates 70 for the annular stator core 11 are formed. Subsequently, regarding the last plates 14, punching is performed a plurality of times using the die for forming a general plate 70 and punching is performed using a die for forming an end surface side plate 60. Accordingly, the end surface side plate 60 including the end surface side teeth 63 with no flange portion 76 is formed. The punched plates 14 for the stator core 11 are sequentially rotated by a predetermined angle and are stacked (so-called rotative stacking). Lastly, a plurality of formed plates 14 (predetermined number of general plates 70 and one end surface side plate 60) are caulked. Accordingly, the stator core 11 including the end surface side portion 61 and the general portion 71 is formed.

Next, displacement of the stator core 11 occurring when the rotary electric machine 1 is driven will be described. FIG. 8 is a perspective view showing displacement of the stator core. As shown in FIGS. 1 and 8, if the temperatures of the stator core 11 and the case 2 rise when the rotary electric machine 1 is driven, the stator core 11 and the case 2 expand outward in the radial direction due to linear expansion (thermal expansion). Here, in the present embodiment, since the case 2 is formed of aluminum and the stator core 11 is formed of an electromagnetic steel sheet, there is a difference between the coefficients of linear expansion thereof. More specifically, aluminum forming the case 2 has a higher coefficient of linear expansion than an electromagnetic steel sheet forming the stator core 11. Therefore, if the temperatures of the stator core 11 and the case 2 rise when the rotary electric machine 1 is driven, the case 2 expands more significantly than the stator core 11. In addition, the end surface side portion 61 of the stator core 11 in contact with the case 2 is pulled outward in the radial direction (arrow A direction in FIG. 8) by the case 2. Accordingly, the end surface side teeth 63 of the end surface side portion 61 are displaced outward in the radial direction such that they are laid alongside with the radial direction.

Here, the end surface side teeth 63 of the end surface side portion 61 are formed to have a linear shape in the radial direction having no flange portion 76, as in the general teeth 73. Therefore, even when the end surface side teeth 63 are displaced outward in the radial direction due to a difference between the coefficients of linear expansion of the stator core 11 and the case 2, contact of the segment coil 30 (coil 12) with the insulating coating 8a and the insulating paper 8b in the radial direction is limited.

According to the stator 3 of the present embodiment, since the end surface side teeth 63 having a linear shape in the radial direction are provided as the non-contact portions on the inner circumference side of the end surface side portion 61 of the stator core 11, even when the end surface side portion 61 of the stator core 11 is pulled and displaced outward in the radial direction due to a difference between the coefficients of linear expansion of the stator core 11 and the case 2, contact of the coil 12 with the insulating coating 8a and the insulating paper 8b in the radial direction can be limited. In addition, since the general teeth 73 have the flange portion 76 similar to stator cores in the related art, even if the linear end surface side teeth 63 are provided, influence on performance of the stator 3 can be limited. Therefore, it is possible to provide the stator 3 in which the coil 12 can be prevented from coming into contact with the insulating coating 8a and the insulating paper 8b in the radial direction while influence on performance is limited.

In addition, according to the stator 3 of the present embodiment, since the end surface side teeth 63 are provided as the non-contact portions on the inner circumference side of the end surface side back yoke portion 62, manufacturing can be easily performed by only adding one die to a progressive die for manufacturing a general portion 71. Thus, according to the stator 3 of the present embodiment, the coil 12 can be prevented from coming into contact with the insulating coating 8a and the insulating paper 8b in the radial direction while the manufacturing cost is reduced.

According to the stator 3 of the present embodiment, since the end surface side teeth 63 are formed to have a linear shape in the radial direction, the coil 12 can be prevented from coming into contact with the insulating coating 8a and the insulating paper 8b in the radial direction while influence on performance of the stator 3 is further limited.

According to the rotary electric machine 1 of the present embodiment, since the stator 3 described above is provided, it is possible to achieve a high-performance rotary electric machine 1 in which the coil 12 can be prevented from coming into contact with the insulating coating 8a and the insulating paper 8b in the radial direction while influence on performance is limited.

### Second embodiment

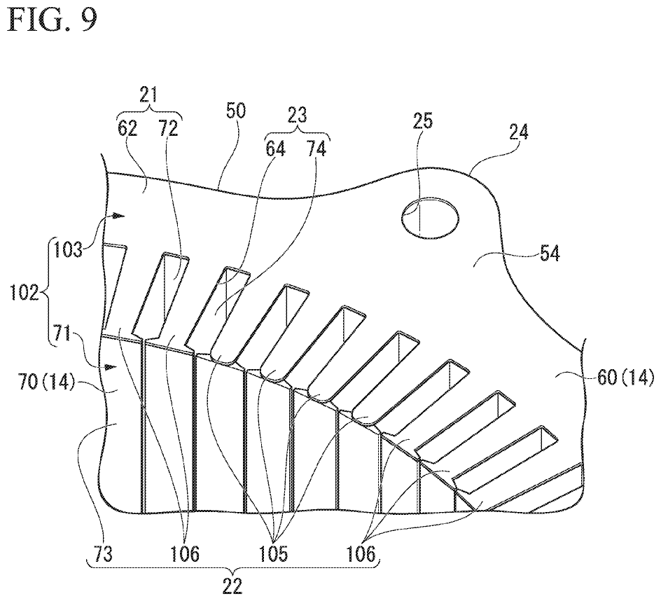

Next, a stator 101 of a second embodiment will be described. FIG. 9 is a perspective view of a stator core of a stator in the second embodiment. As shown in FIG. 9, a stator core 102 includes an end surface side portion 103 and the general portion 71. The end surface side portion 103 has the end surface side back yoke portion 62, a plurality of end surface side teeth 105, and end surface side general teeth 106. The plurality of end surface side teeth 105 and the end surface side general teeth 106 are formed in a manner protruding inward in the radial direction from the inner circumferential surface of the end surface side back yoke portion 62.

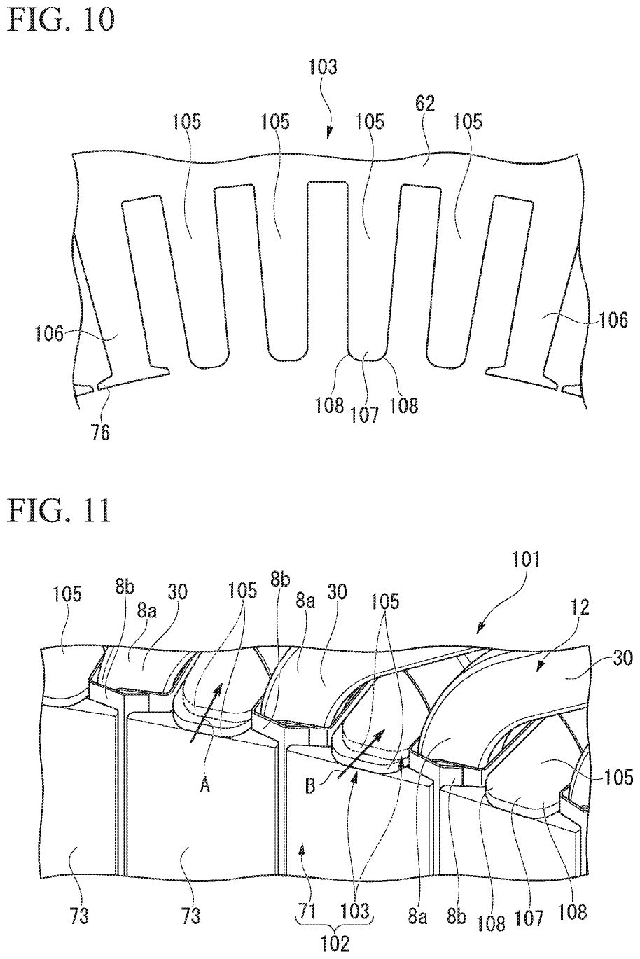

FIG. 10 is a plan view of an end surface side portion of the stator core. As shown in FIGS. 9 and 10, the end surface side teeth 105 are provided at only positions corresponding to the attachment portions 24 in the circumferential direction on the inner circumferential surface of the end surface side back yoke portion 62. In the attachment portions 24, significant displacement occurs due to a difference between the coefficients of linear expansion of the case 2 and the stator core 102, compared to other positions.

The end surface side teeth 105 are formed to have a linear shape. The end surface side teeth 105 are non-contact portions which are incapable of coming into contact with the coil 12 in the radial direction even if the end surface side portion 103 is displaced outward in the radial direction. Both corner portions 108 and 108 of distal end portions 107 of the end surface side teeth 105 are formed to have a chamfered shape. The corner portions 108 of the present embodiment are formed to have a round-chamfered shape. As other chamfered shapes, a C-chamfered shape may be applied.

The end surface side general teeth 106 are provided at positions other than the positions corresponding to the attachment portions 24 in the circumferential direction. The end surface side general teeth 106 are formed to have the same shape as those of the general teeth 73 of the general portion 71 and have the flange portion 76.

Next, displacement of the stator core 102 occurring when the rotary electric machine 1 is driven will be described. FIG. 11 is a perspective view showing displacement of the stator core. If the temperatures of the stator core 102 and the case 2 rise when the rotary electric machine 1 is driven, the end surface side portion 103 of the stator core 102 is pulled outward in the radial direction from the case 2. Accordingly, as shown in FIG. 11, the end surface side teeth 105 of the end surface side portion 103 are displaced outward in the radial direction (arrow “A” direction in FIG. 11). Here, the end surface side teeth 105 are formed to have a linear shape in the radial direction. Therefore, in the end surface side teeth 105, contact of the segment coil 30 (coil 12) with the insulating coating 8a and the insulating paper 8b in the radial direction is limited.

In addition, there are cases in which the end surface side portion 103 is obliquely pulled with respect to the radial direction. This occurs due to the asymmetrical shape of the case 2, the difference in thickness of the case 2 around the attachment portions 24, the size of the rotary electric machine 1, the asymmetrical fastening positions of the bolts 55 of the stator core 102, and the like. If the end surface side portion 103 is obliquely pulled with respect to the radial direction, the end surface side teeth 105 are obliquely displaced with respect to the radial direction in a similar manner (arrow B direction in FIG. 11). In contrast, in the present embodiment, both the corner portions 108 and 108 of the distal end portions 107 of the end surface side teeth 105 are formed to have a chamfered shape. Therefore, in the end surface side teeth 105, contact of the segment coil 30 (coil 12) with the insulating coating 8a and the insulating paper 8b in the radial direction is limited.

According to the stator 101 of the second embodiment, since both the corner portions 108 and 108 in the distal end portions 107 of the end surface side teeth 105 have a chamfered shape, even when the end surface side portion 103 of the stator core 102 is displaced in the radial direction and the circumferential direction, the coil 12 can be prevented from coming into contact with the insulating coating 8a and the insulating paper 8b in the radial direction.

In addition, according to the stator 101 of the present embodiment, since the end surface side teeth 105 serving as the non-contact portions are provided at only positions corresponding to the attachment portions 24, an installation range for the end surface side teeth 105 can be minimized Therefore, the coil 12 can be prevented from coming into contact with the insulating coating 8a and the insulating paper 8b in the radial direction while influence on performance of the stator 101 is further limited.

### Third embodiment

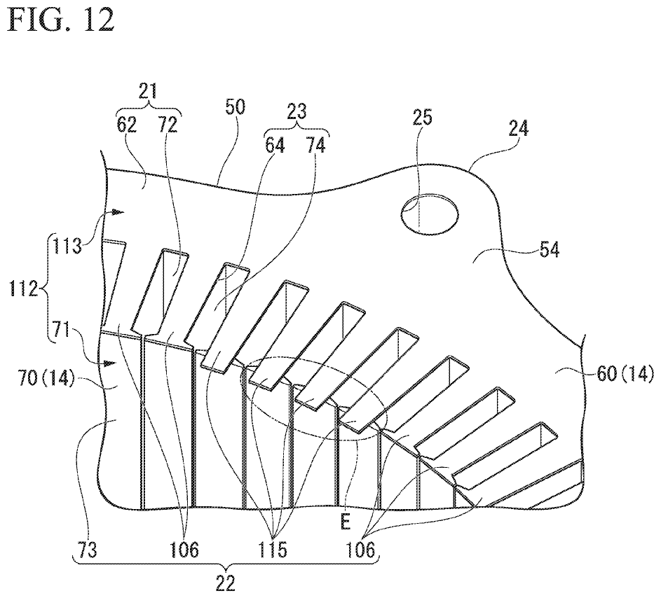

Next, a stator 111 of a third embodiment will be described. FIG. 12 is a perspective view of a stator core of a stator in the third embodiment. As shown in FIG. 12, a stator core 112 includes an end surface side portion 113 and the general portion 71. The end surface side portion 113 has the end surface side back yoke portion 62, a plurality of end surface side teeth 115, and a plurality of end surface side general teeth 106. The plurality of end surface side teeth 115 and the plurality of end surface side general teeth 106 are formed in a manner protruding inward in the radial direction from the inner circumferential surface of the end surface side back yoke portion 62. The plurality of end surface side teeth 115 are provided at only positions corresponding to the attachment portions 24 in the circumferential direction in the end surface side back yoke portion 62.

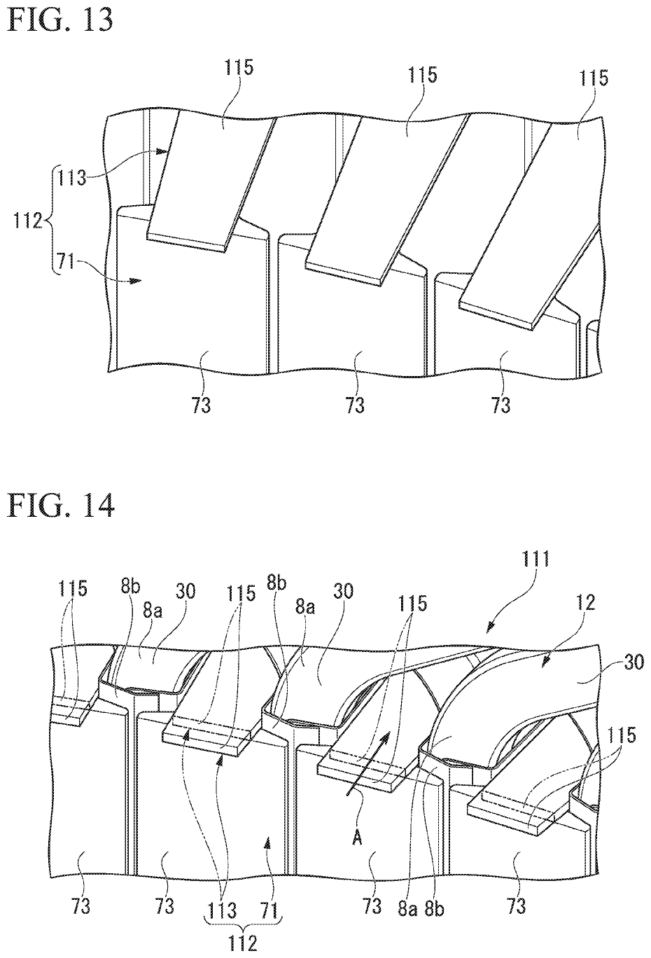

FIG. 13 is an enlarged view of a part E in FIG. 12. In FIG. 13, in order to facilitate the understanding, the protruding amounts of the end surface side teeth 115 are shown in an exaggerated manner.

As shown in FIG. 13, the end surface side teeth 115 are formed to have a linear shape in the radial direction. Moreover, the end surface side teeth 115 are formed in a manner protruding inward in the radial direction beyond the general teeth 73 of the general portion 71. The protruding amount of the end surface side teeth 115 with respect to the general teeth 73 is set to be substantially the same as the displacement amount at the time when outward displacement in the radial direction occurs in the end surface side teeth 115.

Next, displacement of the stator core 112 occurring when the rotary electric machine 1 is driven will be described. FIG. 14 is a perspective view showing displacement of the stator core. If the temperatures of the stator core 112 and the case 2 rise when the rotary electric machine 1 is driven, the end surface side portion 113 of the stator core 112 is pulled outward in the radial direction from the case 2. Accordingly, as shown in FIG. 14, the end surface side teeth 115 of the end surface side portion 113 are displaced outward in the radial direction (arrow “A” direction in FIG. 14). Here, the protruding amount of the end surface side teeth 115 with respect to the general teeth 73 is set to be substantially the same as the displacement amount at the time when outward displacement in the radial direction occurs in the end surface side teeth 115. Therefore, according to the present embodiment, even if the end surface side portion 113 of the stator core 112 is displaced outward in the radial direction due to a difference between the coefficients of linear expansion, the positions of the distal end portions of the end surface side teeth 115 and the positions of the distal end portions of the general teeth 73 can be substantially the same as each other. Therefore, the coil 12 can be prevented from coming into contact with the insulating coating 8a and the insulating paper 8b in the radial direction while influence on performance of the stator 111 is further limited.

The technical scope of the present invention is not limited to the embodiments described above, and various modifications can be added within a range not departing from the gist of the present invention.

In the stators 3, 101, and 111 of the embodiments described above, the end surface side portions 61, 103, and 113 of the stator cores 11, 102, and 112 include the end surface side back yoke portion 62 and the plurality of end surface side teeth 63, 105, and 115. However, they may include only the end surface side back yoke portion 62 without including the end surface side teeth 63, 105, and 115. In this case, an inner circumference side portion of the end surface side back yoke portion 62 constitutes a non-contact portion.

Furthermore, the constituent elements in the foregoing embodiments can be suitably replaced with known constituent elements within a range not departing from the gist of the present invention. In addition, the embodiments and the modification examples described above may be suitably combined.

What is claimed is:

1. A stator comprising:
a coil that has a surface surrounded by an insulating portion; and
an annular stator core that is formed of stacked plates and has a slot in which the coil is mounted,
wherein the stator core includes an end surface side portion which forms a part of the stator core on an end surface side to be in contact with a stator support member, and a general portion which forms a part other than the end surface side portion,
wherein the general portion includes a plurality of general teeth which are provided at intervals in a circumferential direction of the stator core and of which distal ends have a flange portion extending in the circumferential direction, and
wherein non-contact portions, which are incapable of coming into contact with the coil in a radial direction even if the end surface side portion is displaced outward in the radial direction of the stator core, are provided in the end surface side portion.

2. The stator according to claim 1,
wherein the end surface side portion has an end surface side back yoke portion stacked in the general portion on an outer side of the general teeth in the radial direction, and
wherein the non-contact portions are provided on an inner circumference side of the end surface side back yoke portion.

3. The stator according to claim 1,
wherein the end surface side portion has end surface side teeth stacked in the general teeth, and
wherein the non-contact portions are constituted of the end surface side teeth which are formed to have a linear shape in the radial direction.

4. The stator according to claim 3,
wherein both corner portions in distal end portions of the end surface side teeth have a chamfered shape.

5. The stator according to claim 3,
wherein the end surface side teeth protrude inward in the radial direction beyond the general teeth.

6. The stator according to claim 1,
wherein attachment portions for being attached to the stator support member are provided in the stator core, and
wherein the non-contact portions are provided at only positions corresponding to the attachment portions.

7. A rotary electric machine comprising:
the stator according to claim 1.
